(19) United States
(12) Patent Application Publication
(10) Pub. No.: US 2014/0203615 A1
(43) Pub. Date: Jul. 24, 2014

(54) HEAD RESTRAINT ASSEMBLY FOR A VEHICLE

(71) Applicant: WINDSOR MACHINE & STAMPING, LTD, Windsor (CA)

(72) Inventor: Mark Little, Maidstone (CA)

(73) Assignee: WINDSOR MACHINE & STAMPING, LTD, Windsor (CA)

(21) Appl. No.: 14/161,138

(22) Filed: Jan. 22, 2014

Related U.S. Application Data
(60) Provisional application No. 61/755,162, filed on Jan. 22, 2013.

(51) Int. Cl. B60N 2/48

(52) U.S. Cl. CPC B60N 2/4841
USPC 297/408

(57) ABSTRACT

A head restraint assembly for a vehicle seat includes a base portion, a head restraint, and a locking mechanism. The head restraint is mounted with respect to the base portion and is selectively rotatable with respect to the base portion about a first axis. The locking mechanism includes a first lock member, a second lock member, and a first spring. The first lock member is mounted with respect to the base portion and defines a first plurality of teeth. The second lock member is movably mounted with respect to the head restraint and the first lock member. The second lock member defines a second plurality of teeth. The first spring continuously biases the second lock member toward the first lock member such that the second plurality of teeth continuously contact the first plurality of teeth.

### CROSS-REFERENCE TO RELATED APPLICATIONS

This application claims the benefit of U.S. Provisional Patent Application No. 61/755,162 filed on Jan. 22, 2013, which is hereby incorporated by reference in its entirety.

### TECHNICAL FIELD

The present disclosure is related to head restraint assembly for a vehicle.

### BACKGROUND

Many vehicles, such as automobiles, include a headrest or a head restraint atop an occupant's seat and in a position adjacent the occupant's head. Head restraints are typically cushioned for comfort, are height adjustable, and most are commonly finished in the same material as the rest of the seat.

### SUMMARY

One possible aspect of the disclosure provides a head restraint assembly for a vehicle seat. The head restraint assembly includes a base portion, a head restraint, and a locking mechanism. The head restraint is mounted with respect to the base portion and is selectively rotatable with respect to the base portion about a first axis. The locking mechanism includes a first lock member, a second lock member, and a first spring. The first lock member is mounted with respect to the base portion and defines a first plurality of teeth. The second lock member is movably mounted with respect to the head restraint and the first lock member. The second lock member defines a second plurality of teeth. The first spring continuously biases the second lock member toward the first lock member such that the second plurality of teeth continuously contact the first plurality of teeth.

In another aspect of the disclosure, a vehicle seat includes a seatback and a head restraint assembly. The head restraint assembly includes a base portion, a head restraint, and a locking mechanism. The base portion is operatively connected to the seatback. The head restraint is mounted with respect to the base portion and is selectively rotatable with respect to the base portion and the seatback about a first axis. The locking mechanism includes a first lock member, a second lock member, and a first spring. The first lock member is mounted with respect to the base portion and defines a first plurality of teeth. The second lock member is movably mounted with respect to the head restraint and the first lock member. The second lock member defines a second plurality of teeth. The first spring continuously biases the second lock member toward the first lock member such that the second plurality of teeth continuously contact the first plurality of teeth.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

FIG. 1 is a schematic perspective view of a head restraint assembly.

FIG. 2 is an enlargement of the area “FIG. 2,” as provided in FIG. 1.

FIG. 3 is a schematic perspective view of a portion of the head restraint assembly of FIG. 1.

FIG. 4 is a schematic partial cross-sectional front view of a portion of the head restraint assembly of FIG. 1 with a button in an unpressed position, a compression spring and a coil spring in an uncompressed position, and a first lock member engaged with a second lock member.

FIG. 5 is a schematic side view of a portion of the head restraint assembly of FIG. 1, taken along line 4-4 of FIG. 5.

FIG. 6 is a schematic partial cross-sectional front view of the portion of the head restraint assembly of FIG. 4 with the button in a depressed position and the compression spring and the coil spring in a compressed position, and the first lock member disengaged from the second lock member.

FIG. 7 is a schematic partial cross-sectional front view of the portion of the head restraint assembly of FIG. 4 with the button in the unpressed position, the compression spring and the coil spring in the uncompressed position, and the first lock member engaged with the second lock member.

FIG. 8 is a partial cross-sectional front view of the portion of the head restraint assembly of FIG. 6 with the button in the depressed position and the compression spring and the coil spring in the compressed position, and the first lock member disengaged from the second lock member.

### DESCRIPTION OF THE PREFERRED EMBODIMENTS

Referring to the drawings, wherein like reference numbers refer to like components throughout the several Figures, a head restraint assembly 10 is shown schematically. The head restraint assembly 10 includes a base portion 14 that is mountable to a vehicle seat 12, and, more specifically, to an upper portion of a seatback 16 of the vehicle seat 12. In the embodiment depicted, the base portion 14 includes two post members 18 that are mounted, or mountable, to a top of the seatback 16 of the vehicle seat 12, as understood by those skilled in the art. Each post member 18 includes a respective elongated, straight portion 22. Each straight portion 22 extends into a respective hole formed in the top of the seatback 16 to facilitate attachment of the head restraint assembly 10 to the vehicle seat 12. The base portion 14 also includes a cross-member 26 that interconnects the two post members 18.

The head restraint assembly 10 further includes a head restraint 30 mounted with respect to the base portion 14. The head restraint 30 includes a head restraint frame 34 that provides rigid structure to the head restraint 30. The head restraint 30 also includes a cushion 20 and a head restraint cover that are mounted with respect to the frame 34 for movement therewith. The head restraint cushion 20 is comprised of a soft foam or a like material to provide a cushion between the head of a human occupant of the vehicle seat 12 and the head restraint frame 34. The head restraint cover covers at least part of the cushion 20 and the frame to enhance the aesthetics of the head restraint. Exemplary cover materials include cloth, vinyl, leather, etc.

The frame 34 in the embodiment depicted includes a generally C-shaped frame member 38. The frame member 38 includes a first straight portion 42 that is rotatably connected to the cross-member 26, adjacent one of the post members 18. The frame member 38 includes a second straight portion 46 that is connected to the first straight portion 42 and extends perpendicularly from the first straight portion 42 (parallel to the cross-member 26). The frame member 38 further includes a third straight portion 50 that extends perpendicularly from the second straight portion 46 towards the cross-member 26 such that the third straight portion 50 extends in spaced and generally parallel relationship to the first straight portion 42. A bracket 54 of the frame 34 connects the third straight portion 50 of member 38 to the cross-member 26. The bracket 54 may be formed from stamping and the like.

The frame 34 is rotatably mounted with respect to the base portion 14 such that the frame 34, along with the rest of the head restraint 30 (including the cushion 20 and the cover) is selectively rotatable with respect to the base portion 14, and, therefore, is also selectively rotatable with respect to the seatback 16 portion of the vehicle seat 12. In the embodiment depicted, the cross-member 26 extends through holes 55 formed in the first straight portion 42 of the frame member 38 and the bracket 54 so that the frame member 38 and the bracket 54 are connected to the base portion 14 but also rotatable about an axis A1 that extends through the cross-member 26.

The head restraint assembly 10 also includes a locking mechanism 58 configured to selectively lock the head restraint 30 with respect to the base portion 14, to thereby prevent rotation of the head restraint 30 relative to the base portion 14. The locking mechanism 58 is configured such that a vehicle user or occupant can adjust the rotational (i.e., angular) position of the head restraint 30 about the axis A1, relative to the base portion 14 (and the seatback 16 of the seat 12) to optimize comfort. More specifically, the locking mechanism 58 selectively locks the head restraint 30 about the axis A1, in any one of a plurality of different rotational positions.

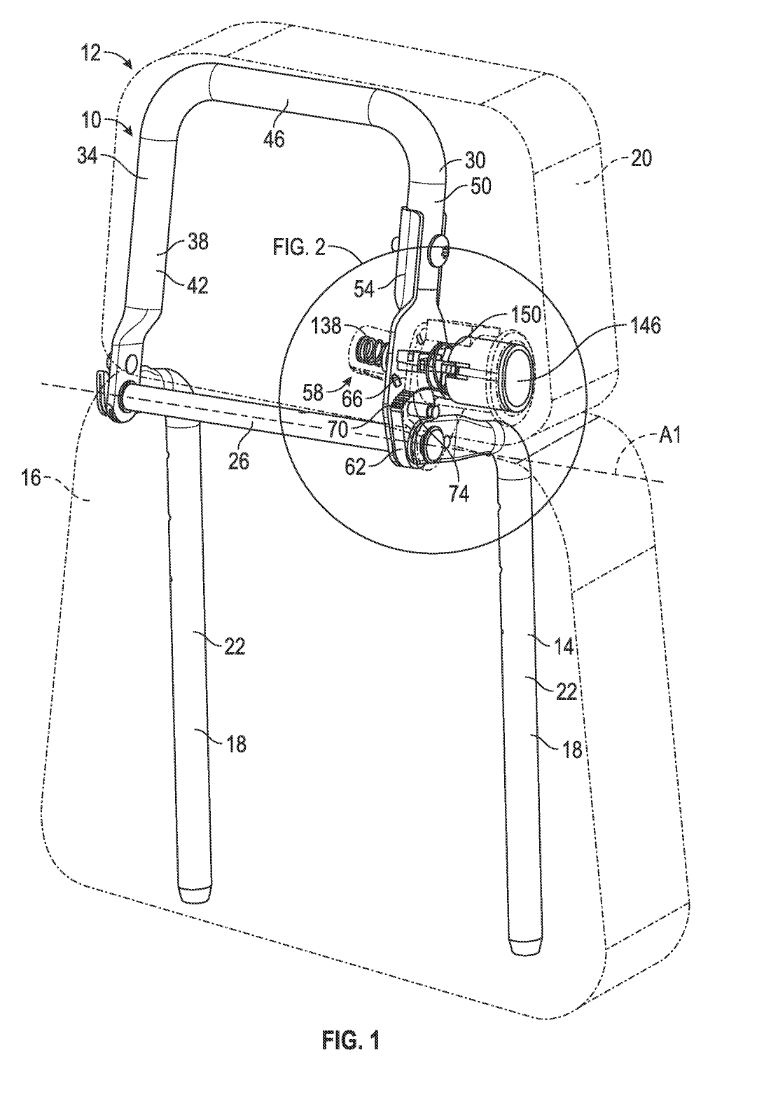

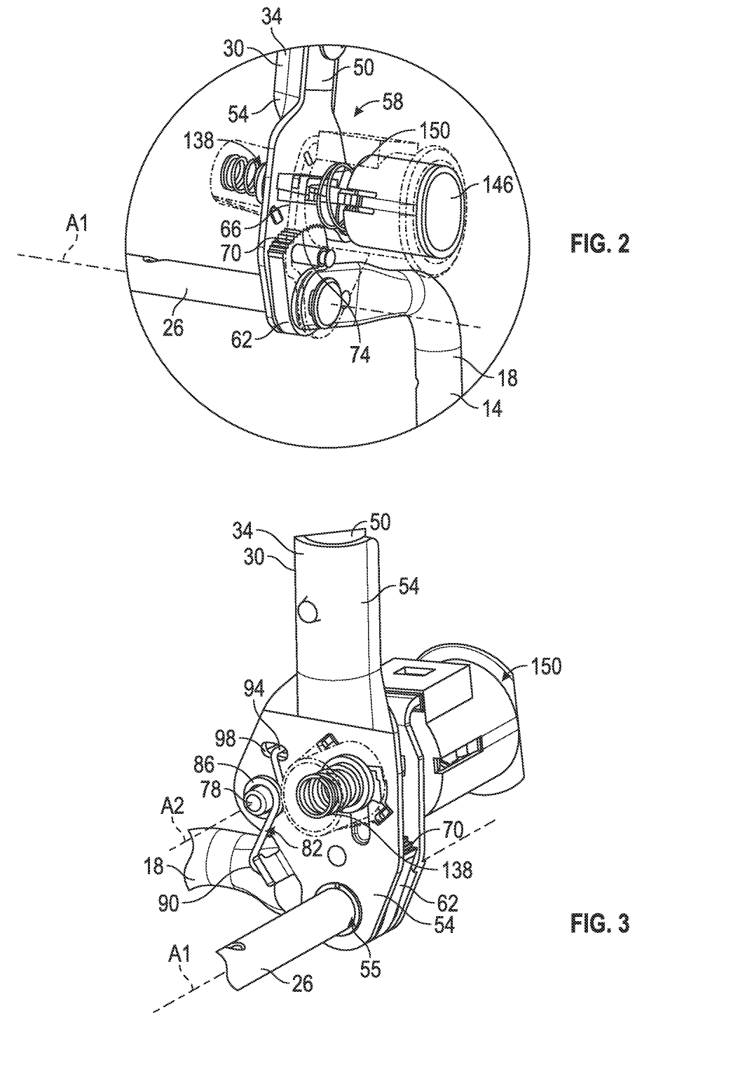

Referring to FIGS. 1-5, the locking mechanism 58 includes a first lock member 62, which may be referred to as a “lock plate”, and a second lock member 66, which may be referred to as a “lock lever”. The first lock member 62 is mounted with respect to the base portion 14 and defines a first plurality of teeth 70 arranged on a surface forming an arc, as shown in FIG. 5, having axis A1 at its center. The second lock member 66 defines a second plurality of teeth 74 arranged on a surface having axis A1 at its center when the second lock member 66 is in the position shown in FIG. 5. The second lock member 66 is rotatably mounted with respect to the head restraint 30 via a fastener 78 such that the second lock member 66 is selectively rotatable with respect to the frame 34 about axis A2, which extends in spaced and parallel relationship to axis A1. The second lock member 66 is disposed such that the second plurality of teeth 74 are in contact with, and therefore engageable with, the first plurality of teeth 70.

The first and second lock members 62, 66 are arranged such that, when the head restraint 30, including frame 34, is rotated about axis A1, relative to the base portion 14, the second lock member 66 slides across the first lock member 62, and, more specifically, the second plurality of teeth 74 slide across the first plurality of teeth 70. The teeth 70, 74 are not self-locking More specifically, the teeth 70, 74 do not prevent rotation of the head restraint 30 about axis A1 so long as the second lock member 66 is free to pivot about axis A2. As the second lock member 66 slides across the first lock member 62, the first plurality of teeth 70 force the second plurality of teeth 74 axially away from the axis A1, i.e., upward, as viewed in the figures, and away from the first lock member 62, as each of the teeth 74 traverses over a respective one of the teeth 70 until further rotation of the frame 30 causes each of the teeth 74 to rest in respective spaces between the teeth 70. The upward movement of teeth 74 caused by teeth 70 (during rotation of the frame 34 about axis A1) results in the second lock member 66 pivoting about axis A2.

Referring to FIGS. 3-8, a first spring 82 biases the second lock member 66 into contact with the first lock member 62 to ensure that contact between the first and second pluralities of teeth 70, 74 is maintained during operation of the head restraint assembly 10. In the embodiment depicted, the first spring 82 may be a torsion spring disposed primarily on the opposite side of the bracket 54 from the first and second lock members 62, 66. The first spring 82 includes a coiled portion 86 that is wound about the fastener 78. One end 90 of the first spring 82 is operatively connected to the bracket 54, and the other end 94 of the first spring 82 extends through a hole 98 in the bracket 54 and is connected to, or is in abutting relationship to, the second lock member 66 to exert force thereon.

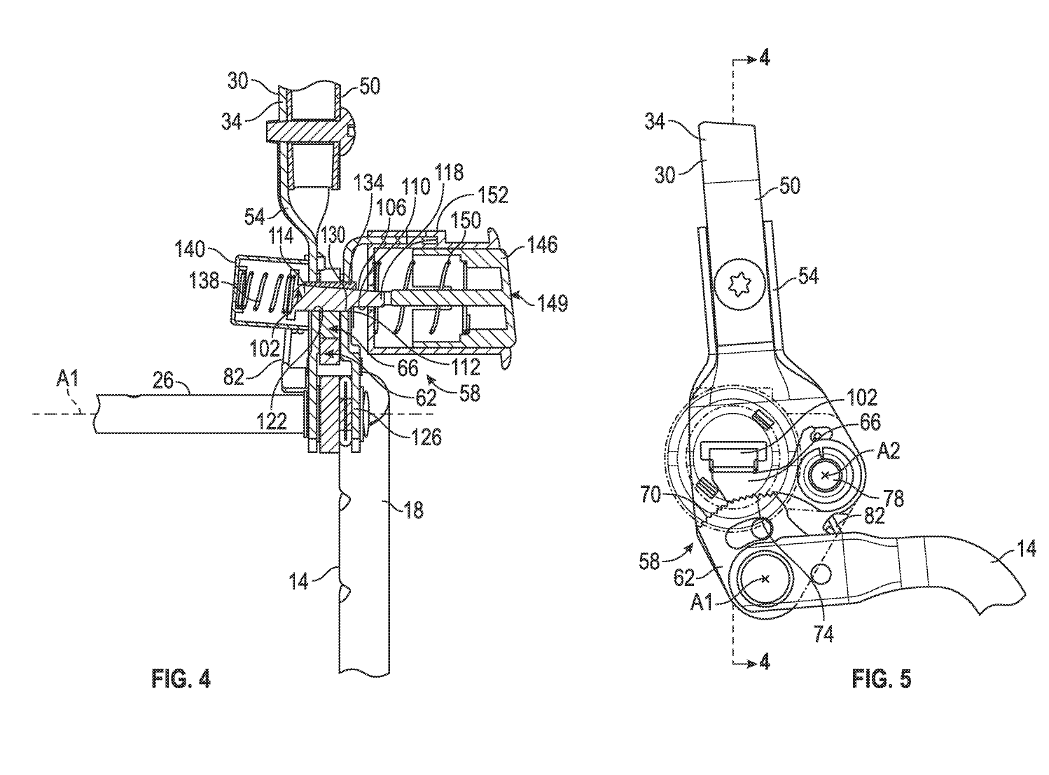

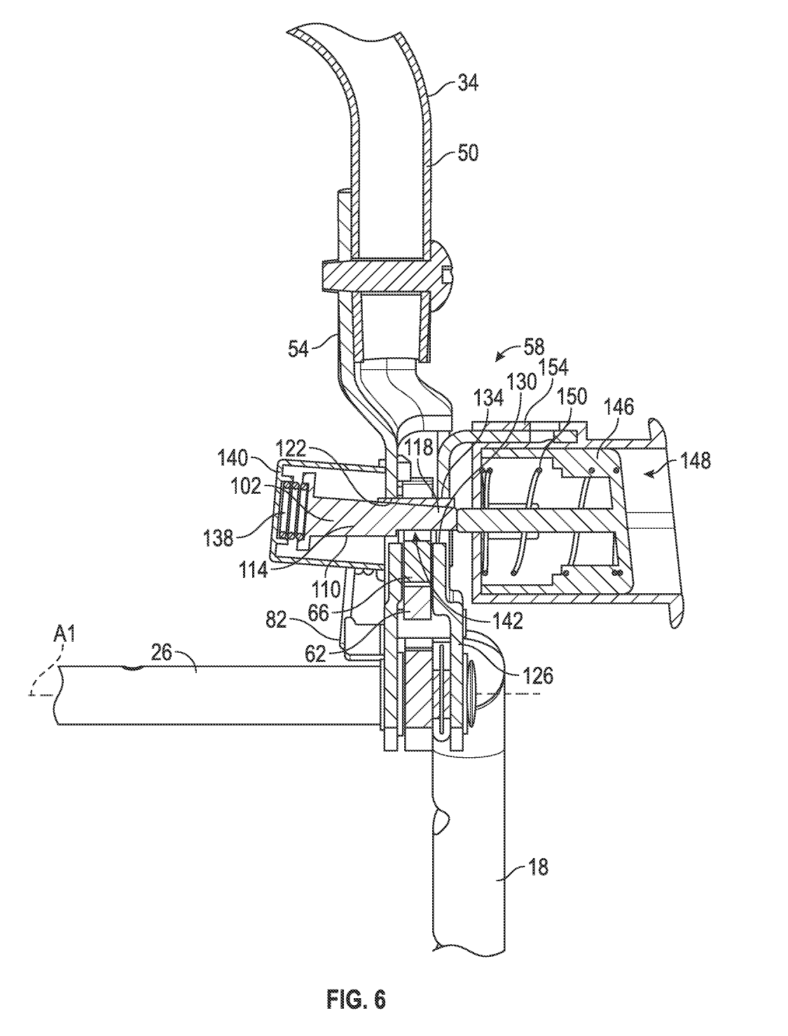

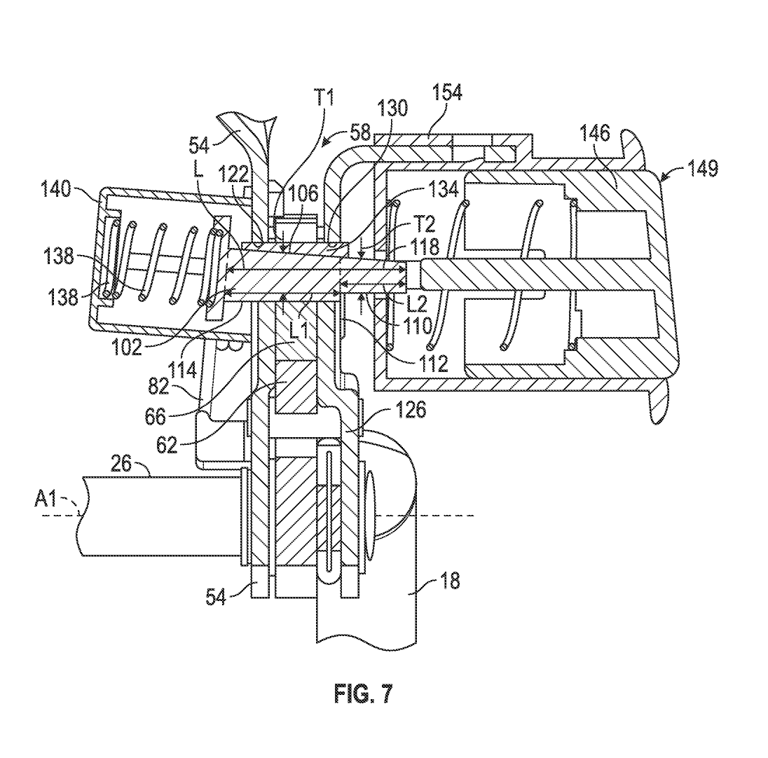

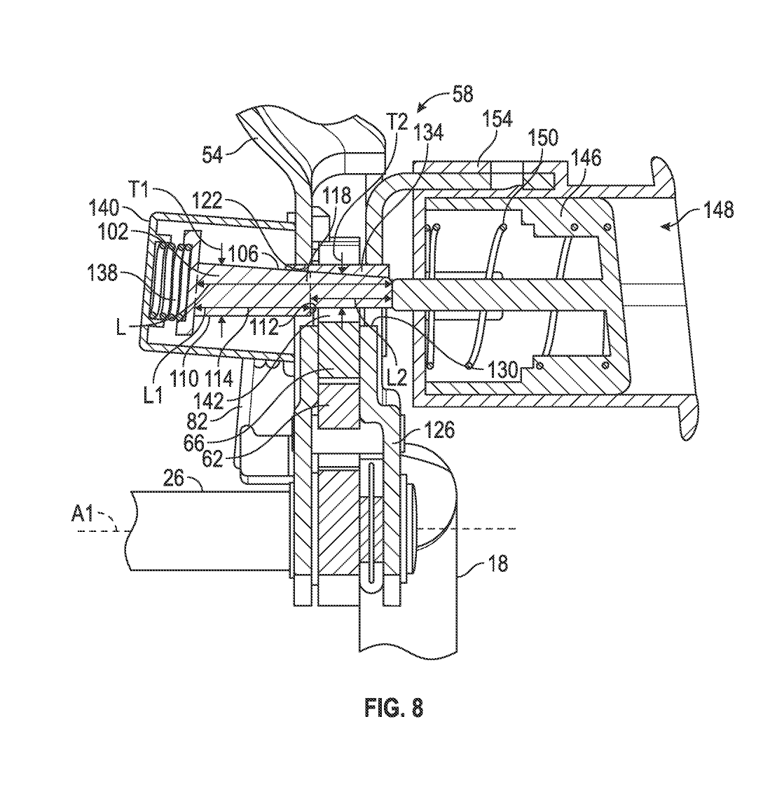

Referring to FIGS. 4 and 6-8, the head restraint assembly 10 also includes a wedge member 102 that is mounted with respect to the head restraint 30 and is selectively movable with respect to the head restraint 30 between a first position, as shown in FIGS. 4 and 7, and a second position, as shown in FIGS. 6 and 8. The wedge member 102 is positioned and configured such that the wedge member 102 prevents movement of the second lock member 66 relative to the first lock member 62 when the wedge member 102 is in the first position, and permits movement of the second lock member 66 relative to the first lock member 62 when the wedge member 102 is in the second position.

More specifically, with specific reference to FIGS. 7 and 8, the wedge member 102 is characterized by a flat surface 106 on one side, and on the opposite side, the wedge member 102 is characterized by a stepped or inclined surface 110 that results in a thickness T of the wedge member 102 varying across its length L. In the embodiment depicted, surface 110 includes a step 112 that results in a first segment 114 of the wedge member 102 (on one side of the step) having a first thickness T1, and a second segment 118 of the wedge member 102 (on the other side of the step) having a second thickness T2. The first thickness T1, which extends along a first length L1, is greater than the second thickness T2, which extends along a second length L2. The length L is at least equal to a total of the first length L1 and the second length L2.

Referring again to FIGS. 4 and 6-8, the bracket 54 defines a hole 122 through which the wedge member 102 extends. The locking mechanism 58 includes a plate 126 that is rotatably mounted to the cross member 26 for selective rotation about axis A1. The plate 126 is mounted with respect to the cross member 26 such that the plate 126 and the frame 34 move as a single unit. The plate 126 is positioned such that the lock members 62, 66 are disposed between bracket 54 and plate 126. The plate 126 defines a hole 130. The wedge member 102 extends through the hole 122 defined by bracket 54 and the hole 130 defined by plate 126. Another wedge-shaped member 134 also extends through the holes 122, 130 and prevents radially-outward (relative to axis A1) movement of the wedge member 102.

When the wedge member 102 is in the first position, as shown in FIGS. 4 and 7, the first segment 114 of the wedge member 102 contacts the second lock member 66, thereby preventing any rotation of the second lock member 66 about axis A2. The wedge member 102 thereby prevents the teeth 74 from traversing teeth 70, and thus prevents rotation of the head restraint 30 about axis A1. A second spring 138 may be a compression spring that is operatively disposed adjacent the first segment 114 of the wedge member 102, opposite the second segment 118. A cap 140 is operatively attached to the bracket 54 such that the compression spring 138 is compressibly disposed between the cap 140 and the first segment 114 of the wedge member 102. As such, the compression spring 138 reacts between the cap 140 and the wedge member 102 to bias the wedge member 102 into the first position.

When the wedge member 102 is in the second position, as shown in FIGS. 6 and 8, the second segment 118 of the wedge member 102 is directly above the second lock member 66; the wedge member 102 does not contact the second lock member 66 when in the second position, because the second segment 118 is thinner than the first segment 114, thereby creating a gap 142 between the wedge member 102 and the second lock member 66. The gap 142 enables the second lock member 66 to sufficiently rotate about axis A2 so that the teeth 74 can traverse teeth 70. Thus, when the wedge member 102 is in the second position, the head restraint 30 is locked and cannot rotate relative to the base portion 14, about axis A1. More specifically, each of the teeth 74 is disposed within a respective valley formed between two of the teeth 70 on the first lock member 62. For the second lock member 66 to move relative to the first lock member 62 and the base portion 14, the teeth 74 must move out of the valleys along the inclined surfaces that form teeth 70. The wedge member 102 permits such movement of the teeth 74 across teeth 70 when the wedge member 102 is in the second position, but prevents such movement of the teeth 74 across teeth 70 when the wedge member 102 is in the first position.

A push button 146 is mounted adjacent to the second segment 118 of the wedge member 102. When the button 146 is pushed, as shown at 148 in FIGS. 6 and 8, the button 146 acts on the wedge member 102 such that the wedge member 102 is moved to the first position, thereby unlocking the head restraint 30. The teeth 70, 74 provide incremental detents when the head restraint 30 is rotatably adjusted forward or rearward about axis A1. Once the button 146 is released, as shown at 149 in FIGS. 4 and 7, the compression spring 138 allows the wedge member 102 to return to the first position, thereby locking the head restraint 30. A third spring 150, which may be a coil spring, is compressibly disposed between the button 146 and a reaction surface 152 such that the coil spring 150 continuously reacts between the reaction surface 152 and the button 146. The reaction surface 152 may be part of a base member 154, operatively attached to the plate 126. Alternatively, the reaction surface 152 may be a portion of the plate 126. The coil spring 150 is configured to continuously bias the button 146 to its unpressed position 149.

Lock teeth 70, 74 not only ensure that the mechanism 58 does not slip under any for/aft load, but also ensure there is no looseness or “chucking” between the two components 34, 14.

This design provides 31.5 degrees of total rotation adjustment about the axis A1, at very small increments of 4.5 degrees (i.e., the teeth 70 are spaced apart from one another such that detent positions of the head restraint 30 are 4.5 degrees apart). In the embodiment disclosed, the total fore/aft package space is less than 45 millimeters (mm). When in the locked position, no looseness or chuck in the mechanism is present.

While the best modes for carrying out the invention have been described in detail, those familiar with the art to which this invention relates will recognize various alternative designs and embodiments for practicing the invention within the scope of the appended claims.

1. A head restraint assembly for a vehicle seat, the head restraint assembly comprising:
a base portion;
a head restraint mounted with respect to the base portion and selectively rotatable with respect to the base portion about a first axis;
a locking mechanism including a first lock member, a second lock member, and a first spring;
wherein the first lock member is mounted with respect to the base portion and defines a first plurality of teeth;
wherein the second lock member is movably mounted with respect to the head restraint and the first lock member;
wherein the second lock member defines a second plurality of teeth; and
wherein the first spring continuously biases the second lock member toward the first lock member such that the second plurality of teeth continuously contact the first plurality of teeth.

2. The head restraint assembly of claim 1, further comprising a wedge member mounted with respect to the head restraint and being selectively movable with respect to the head restraint between a first position and a second position;
wherein the wedge member is positioned and configured such that the wedge member prevents movement of the second lock member relative to the first lock member when the wedge member is in the first position, and the wedge member permits movement of the second lock member relative to the first lock member when the wedge member is in the second position.

3. The head restraint assembly of claim 2, wherein the first and second pluralities of teeth are not self-locking.

4. The head restraint assembly of claim 2, wherein the second plurality of teeth are engaged with the first plurality of teeth to thereby prevent rotation of the head restraint relative to the base portion when the wedge member is in the first position; and
wherein the second plurality of teeth are slidable across the first plurality of teeth to thereby allow rotation of the head restrain relative to the base portion when the wedge member is in the second position.

5. The head restraint assembly of claim 4, wherein the wedge member extends along a length and the wedge member has a thickness that varies across the length.

6. The head restraint assembly of claim 5, wherein the wedge member includes a first segment having a first thickness extending across a first length and the wedge member includes a second segment having a second thickness extending across a second length; and
wherein the first thickness is greater than the second thickness.

7. The head restraint assembly of claim 6, further comprising a second spring that continuously biases the wedge member in the first position.

8. The head restraint of claim 7, further comprising a button that is operatively connected to the wedge member such that the button moves the wedge member to the second position when the button is depressed.

9. The head restraint assembly of claim 4, where the second lock member is rotatably mounted with respect to the head restraint about a second axis.

10. The head restraint assembly of claim 9, wherein the second axis extends in spaced and parallel relationship to the first axis.

11. The head restraint assembly of claim 9, wherein the second plurality of teeth are movable about the second axis, relative to the first axis.

12. The head restraint assembly of claim 11, wherein the second lock member is a lever that is selectively pivotable with respect to the head restraint about the second axis.

13. The head restraint assembly of claim 12, wherein the first spring is a torsion spring operatively disposed to react between the second lock member and the head restraint; and
wherein the torsion spring continuously biases the second lock member into contact with the first lock member.

14. A vehicle seat comprising:
a seatback; and
a head restraint assembly including:
a base portion operatively connected to the seatback;
a head restraint mounted with respect to the base portion and selectively rotatable with respect to the base portion and the seatback about a first axis;
a locking mechanism including a first lock member, a second lock member, and a first spring;
wherein the first lock member is mounted with respect to the base portion and defines a first plurality of teeth;
wherein the second lock member is movably mounted with respect to the head restraint and the first lock member;
wherein the second lock member defines a second plurality of teeth; and
wherein the first spring continuously biases the second lock member toward the first lock member such that the second plurality of teeth continuously contact the first plurality of teeth.

15. The vehicle seat of claim 4, further comprising a wedge member mounted with respect to the head restraint and being selectively movable with respect to the head restraint between a first position and a second position;
wherein the wedge member is positioned and configured such that the wedge member prevents movement of the second lock member relative to the first lock member when the wedge member is in the first position, and the wedge member permits movement of the second lock member relative to the first lock member when the wedge member is in the second position.

16. The vehicle seat of claim 15, wherein the first and second pluralities of teeth are not self-locking

17. The vehicle seat of claim 15, wherein the second plurality of teeth are engaged with the first plurality of teeth to thereby prevent rotation of the head restraint relative to the base portion and the seatback when the wedge member is in the first position; and
wherein the second plurality of teeth are slidable across the first plurality of teeth to thereby allow rotation of the head restrain relative to the base portion and the seatback when the wedge member is in the second position.

18. The vehicle seat of claim 17, wherein the wedge member extends along a length and the wedge member has a thickness that varies across the length.

19. The vehicle seat of claim 18, wherein the wedge member includes a first segment having a first thickness extending across a first length and the wedge member includes a second segment having a second thickness extending across a second length; and
wherein the first thickness is greater than the second thickness.

20. The vehicle seat of claim 19, further comprising a second spring that continuously biases the wedge member in the first position.
